(19) United States
(12) Patent Application Publication
(10) Pub. No.: US 2019/0045778 A1
(43) Pub. Date: Feb. 14, 2019

(54) EMULSIFIABLE CONCENTRATES

(71) Applicant: Dow Global Technologies LLC, Midland, MI (US)

(72) Inventors: Wei Lu, Shanghai (CN); Hua Ren, Shanghai (CN); Ling Zhong, Shanghai (CN); Jianhai Mu, Shanghai (CN); Dong Yun, Shanghai (CN)

(73) Assignee: Dow Global Technologies LLC, Midland, MI (US)

(21) Appl. No.: 16/085,782

(22) PCT Filed: Mar. 17, 2016
(86) PCT No.: PCT/CN2016/076631

§ 371 Date: Sep. 17, 2018

(30) Foreign Application Priority Data
Mar. 17, 2016 (CN) PCT/CN2016/076631

(51) Int. Cl. A01N 25/02; A01N 25/30

(52) U.S. Cl. CPC A01N 25/02; A01N 51/00; A01N 2300/00; A01N 25/30

(57) ABSTRACT

A polar pesticide formulation including: (a) a polar pesticide active ingredient; (b) a solvent package which can be a mixture of: (bi) at least one water-miscible low toxicity and high polarity solvent package; and (bii) at least one water-immiscible eco-friendly and low polarity solvent package; and (c) a complex surfactant package which can be a mixture of: (ci) at least one nonionic surfactant; and (cii) at least one anionic surfactant.

### FIELD

The present invention is related to an emulsifiable concentrate composition; and more specifically, to an active emulsifiable concentrate useful as a polar pesticide formulation.

### BACKGROUND

Emulsifiable concentrate (EC) formulations are known as pesticide formulations in the agriculture market. Heretofore, EC formulations included a conventional solvent such as benzene, toluene, xylene, methanol and dimethyl formamide (DMF), and the like in the formulation to achieve a high concentration of active ingredient (A.I.) in solution due to the A.I being highly soluble in the above conventional solvents. However, the aforementioned conventional solvents commonly used in EC formulations are highly toxic. Because the trend in the industry is in the direction of more restrictive regulations related to highly toxic solvents, the industry desires to: (1) remove completely the above known highly toxic solvents from pesticide formulations; (2) replace the above known highly toxic solvents with non-toxic solvents in pesticide formulations; or (3) reduce or minimize the use of the above known highly toxic solvents in pesticide formulations.

Replacing or removing a solvent from an EC formulation can lead to various problems in the final prepared EC formulation without a solvent or with a replacement solvent. The use of an EC formulation without one of the known solvents described above can negatively impact the properties of the EC formulation, especially for an EC formulation containing an A.I. with a relatively high polarity. For example, using an EC formulation without a solvent leads to the physical instability and a reduced shelf life of the EC formulation. Also, replacing a solvent with excellent dissolving capability with a different solvent having a lower dissolving capability will result in a lower pesticide concentration, that is, a high concentration of A.I. in the EC formulation will not be achievable by using a solvent having a poor dissolving capability. In addition, solvents which provide a low solubility for an A.I. can cause decrease physical stability of the active solution, generating crystals below ambient temperature.

Furthermore, replacing or removing a solvent from an EC formulation can lead to the problem of crystallization in the diluted formulation. The water miscible characteristics of polar solvents can also result in poor dilution stability when diluting the EC formulation with water. The problem of A.I. crystal formation usually occurs during dilution and thus, reduces the active efficacy of the A.I. It is theorized that the migration of polar solvent to water is the reason a polar solvent can decrease the solvent-active ratio of the EC formulation, and thus, leads to crystallization with an over dosage of A.I.

Typically, for a non-conventional EC formulation to qualify for use in a pesticide formulation in the agriculture market, the EC formulation needs to meet the following specifications: (1) the EC formulation cannot include any of the known highly toxic solvents described above; (2) the solvent package used in the EC formulation has to have an A.I. solubility sufficient to provide a high concentration of A.I. in the solvent, that is, no crystals can form in the EC formulation after 1 week of storage at a temperature of less than or equal to 0 degrees Celsius (° C.); and (3) the EC formulation dilution stability, after diluting the EC formulation in water, is such that no crystal formation in found in the EC formulation after diluting the EC formulation twenty times (20×) in hard water and storing the EC formulation for a two-hour storage period under 30° C. However, the above criteria for qualifying an EC formulation for use as a pesticide formulation in the agriculture market, has heretofore been difficult to meet using the known EC formulations containing known solvents.

In view of the above, it is very challenging for the skilled person in the art to achieve an EC formulation meeting all of the above requirements. What is needed in the industry is a polarity solvent package that can dissolve a polar A.I. to obtain a solution containing a high concentration of A.I. However, the difficulty in preparing an acceptable EC formulation lies in emulsifying a polar A.I. solution into the highest polarity water to form a stable dilution without forming crystals. Therefore, a universal EC formulation that can be useful for high polar A.I. and that can provide excellent performance would be a significant technical advancement in the art.

Heretofore, others have attempted to find a universal EC formulation that can be useful for high polar A.I. impart an enhanced performance to a pesticide formulation; but the known prior art formulations have not solved the problem of crystal formation in an EC formulation. Also, the known prior art formulations have not provided an adequate EC formulation with sufficient dilution stability, with a solvent package that has an A.I. solubility sufficient to provide a high concentration of A.I. in the solvent. Furthermore, the known prior art formulations typically cannot be produced without a highly toxic solvent. For example, WO2013126947 A1 discloses emulsifiable concentrates formulation comprising one agrochemical active, one emulsifier and a solvent system; the solvent system comprising a combination of benzyl acetate and one water-miscible water-immiscible solvent. However, WO2013126947 A1 does not disclose an adequate solvent system, surfactant system, and formulation universality to work with more than a single specific pesticide A.I.

Various other prior art references disclose various EC formulations. For example, (1) U.S. Pat. No. 5,731,264 discloses an EC formulation for sulfonyl or sulfamoylurea herbicide employing a gamma-butyrolactone based solvent system; (2) U.S. Pat. No. 6,878,674 B2 discloses an EC formulation for phenoxypropionate herbicide, using N-methyl pyrrolidinone (NMP) as a polar solvent; and polyoxyethylene castor oil ether and polyoxyethylene styryl phenyl ether as surfactants; (3) U.S. Pat. No. 8,815,776 B2 discloses an EC formulation for prodiamine active herbicidal ingredient, utilizing a polar aprotic solvent, a fatty acid dialkylamide solvent; an alkyl based ethylene oxide block copolymer emulsifier; an ethoxylated fatty alcohol hydrophilic non-ionic emulsifier; and an anionic emulsifier; (4) WO2013083372 A1 discloses an EC formulation for fluxapyroxad active ingredient, taking advantage of a solvent package of dimethyl sulfoxide (DMSO), benzyl alcohol and alkyl lactate, and a surfactant combination of alkoxylated alcohol and sulfate or sulfonate anionic surfactant; and (5) WO2013087416 A1 claims EC formulation for amide active ingredient, using carbonate and hydrocarbon solvents, non-ionic surfactant.

### SUMMARY

The present invention is directed to a universal emulsifiable concentrate (EC) formulation, including a solvent package and one or more polar active ingredients (A.I.s); wherein the EC formulation contains a high (e.g., greater than 8 weight percent [wt %]) concentration of A.I.; and wherein the EC formulation containing a high concentration of polar A.I. is stable physically and stable when the formulation is diluted with water without the problem of A.I. crystallization forming in the formulation.

One preferred embodiment of the present invention is directed to a polar pesticide formulation including: (a) a polar pesticide active ingredient such as for example imidacloprid, indoxacarb; (b) a solvent package including a mixture of: (bi) a water-miscible, low toxicity, high polarity solvent package; and (bii) a water-immiscible low polarity solvent package; and (c) a complex surfactant package including a mixture of: (ci) a nonionic surfactant and (cii) an anionic surfactant (e.g., a combination of alkoxylated alcohol nonionic surfactant and dialkyl sulfosuccinate anionic surfactant).

Another preferred embodiment of the present invention is directed to a process of manufacturing the above polar pesticide formulation.

One objective of the present invention is to provide a wider scope of useful A.I.s that includes different high polarity AI such as imidacloprid, indoxacarb and the like as compared to the prior art which only covers a single A.I. such as indoxacarb.

Another objective of the present invention is to provide a composition that can be modified to meet real customer needs such as: (1) to minimize the odor issue of prior art components such as odor from cyclohexanone by replacing the prior art solvent with a low odor system such as NMP+DMSO; (2) to provide a composition that utilizes low toxic aromatic solvents; (3) to provide a process that uses low toxic aromatic solvents in a pesticide formulation instead of prior art formulations that use solvents which are not stable; and (4) to provide a revised system utilizing a low toxic aromatic solvent which is more acceptable by the pesticide formulations industry.

The EC formulation of the present invention contains a combination of one or more water-miscible solvents, one or more water-immiscible solvents, one or more nonionic surfactants, and one or more anionic surfactants. The water-miscible solvents may include for example NMP, DMSO or a mixture of these two solvents. The water-immiscible solvents may include for example, Solvesso™ solvent products (solvent products commercially available from ExxonMobile Chemical; Solvesso is a trademark of ExxonMobile Chemical) such as Solvesso 200# solvent oil, methyl soyate or a mixture of these two. The nonionic surfactant may include for example Ecosurr surfactant products (surfactant products commercially available from The Dow Chemical Company; Ecosurf is a trademark of The Dow Chemical Company) such as Ecosurf EH-6; and the anionic surfactant may include for example Triton™ surfactant products (surfactant products commercially available from The Dow Chemical Company; Triton is a trademark of The Dow Chemical Company) such as Triton GR-7M. Advantageously, the above surfactant combination of the present invention provides a synergic effect.

The use of water-miscible solvents is necessary in the formulation to achieve the desired solubility of the polar A.I's in the concentrate and physical stability. However, the presence of high polar water-miscible solvents in the EC formulations cause a problem of crystallization of A.I's when the EC formulations are diluted. There is still a need to provide a stable EC formulation of polar A.I. that is not only physically stable as the EC formulation but also stable on dilution without the problem of crystallization of A.I. Surprisingly, when a package of hydrocarbon mixture and soybean based plant oil is used as co-solvents and a combination of alkoxylated alcohol nonionic surfactant and dialkyl sulfosuccinate anionic surfactant is used as emulsifier, it has been found that the EC formulations of polar A.I. are stable both in EC formulation and on dilution.

With the formulation of the present invention, stable EC formulations can be obtained for lots of polar pesticide active EC formulation under high concentration. The solvent package provides excellent physical stability of high concentration pesticide solution even under 0° C., i.e., no crystal are observed, thus solving the dissolving limitation issue of prior art solutions. The special surfactants package provides excellent dilution stability while the EC formulation is added into a large volume of water, solving the crystallization problem in dilution formulation. Most importantly, the package combination of the present invention shows its universality to tried polar pesticide actives.

### DETAILED DESCRIPTION

In its broadest scope, the present invention includes a polar pesticide formulation including: (a) a polar pesticide active ingredient (A.I.); (b) a solvent package; and (c) a surfactant package. The high polarity pesticides of the present invention can include for example a polar pesticide A.I. as a first required component (a). Generally, the A.I. may include one or more polar chemical groups, such as for example, but not limited to, halogen-substitutes, pyridyl, thiazolyl, amino, hydroxy, carbonyl, sulfydryl, cyanogens, nitrate, nitrite, sulfate, sulfite or cationic ions (e.g., ammonium); and mixtures thereof. At room temperature (˜25° C.), the pesticides of the present invention are solid; and as a solid, the pesticides can be in the form of crystals, powder, granules, and the like, and mixtures thereof.

In one embodiment, specific embodiments of the A.I., component (a), may include, but is not limited to, neonicotinoid pesticides, such as for example imidacloprid, thiamethoxam, clothianidin, acetamiprid, clopyralid, diflufenican, tebuconazole, oxyfluorfen, propanil, oryzalin, propoxur, thiocloprid, buprofezin, indoxacarb, bentazone, and mixtures thereof. The following Table I describes the water solubility of various pesticide A.I. compounds that may be useful in the present invention:

TABLE I

| Pesticide A.I. | A.I. Chemical Structure | Water Solubility |
|---|---|---|
| imidacloprid | 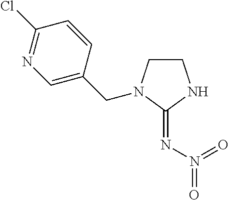 [SMILES: O=[N+]([O-])/N=C1\NCCN1Cc1ccc(Cl)nc1] | 0.61 g/L at 20° C. |
| thiamethoxam | 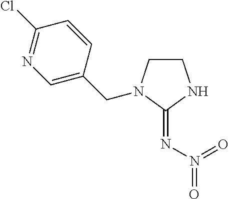 [SMILES: O=[N+]([O-])/N=C1\NCCN1Cc1ccc(Cl)nc1] | 4.1 g/L at 25° C. |
| clothianidin | 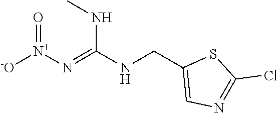 | 0.33 g/L at 20° C. |
| acetamiprid | 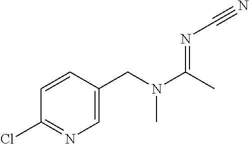 | 4.2 g/L at 20° C. |
| thiacloprid | 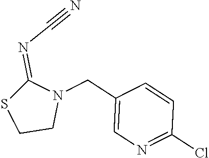 [SMILES: N#C/N=C1/SCCN1Cc1ccc(Cl)nc1] | 0.1 g/L at 20° C. |
| prothioconazole | 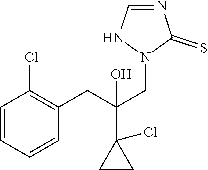 [SMILES: OC(Cc1ccccc1Cl)(Cn1[nH]cnc1=S)C1(Cl)CC1] | 0.3 g/L at 20° C. |
| indoxacarb | 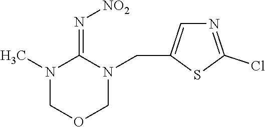 [SMILES: CN1COCN(Cc2cnc(Cl)s2)/C1=N\[N+](=O)[O-]] | 0.51 g/L at 20° C. |
| bentazone | 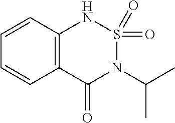 [SMILES: CC(C)N1C(=O)c2ccccc2NS1(=O)=O] | 0.50 g/L at 20° C. |

The concentration of the A.I. used in the formulation of the present invention may range generally from about 5 wt % to about 16 wt % in one embodiment, from about 5 wt % to about 10 wt % in another embodiment, and from about 6 wt % to about 9 wt % in still another embodiment, based on the total weight of components in the formulation. Below the concentration of 5 wt %, the formulation works well but is not cost effective. Above the concentration of 16 wt %, the storage stability performance and the dilution stability performance of the formulation may not be further advantageously exhibited by the formulation.

In terms of parts per 100 parts (g) of pesticide EC, the pesticide A.I. can range from about 2 parts to about 20 parts in one embodiment, and from about 2 parts to about 15 parts in another embodiment.

The EC formulation of the present invention includes a solvent package, as component (b), which comprises a combination of: (bi) a water-miscible solvent and (bii) a water-immiscible solvent as a co-solvent. For example, component (bi), a water-miscible solvent, can include high polarity solvents. For example, the high polarity water-miscible solvent, component (bi), useful in the present invention may include dimethyl isosorbide, gamma-butyrolactone, and mixtures thereof.

A combination of two or more water-miscible solvents, component (bi) can be used as the water-miscible solvent. For example, (bi) may include a mixture of: (biα) a pyrrolidone compound such as NMP; and (biβ) a sulfur-containing compound such as DMSO, and mixtures thereof. In one preferred embodiment, the water-miscible solvent used in the formulation can be for example a mixture of NMP and DMSO in a ratio of NMP to DMSO in the range of from about 3:2 to about 4:1.

In terms of parts per 100 parts (g) of pesticide EC, the concentration of the water-miscible solvent can range from about 20 parts to about 50 parts in one embodiment, and from about 30 parts to about 45 parts in another embodiment.

The component (bii), a water-immiscible solvent, useful in the EC formulation of the present invention can include for example low polarity solvents, such as a hydrocarbon; a coconut-based plant oil; a tobacco leaf-based plant oil; a turpentine-based plant oil; and a combination of two or more of the above water-immiscible solvents.

In another more specific embodiment of the hydrocarbon useful as the water-immiscible solvent component (bii), the hydrocarbon solvent may include for example Solvesso 100# and Solvesso 150#; and mixtures thereof. In another more specific embodiment of the coconut based plant oil useful as the water-immiscible solvent component (bii), the coconut based plant oil may include for example methyl caprylate. In another more specific embodiment of the tobacco leaf based plant oil useful as the water-immiscible solvent component (bii), the tobacco leaf based plant oil may include for example methyl caprate. In another more specific embodiment of the soybean based plant oil useful as the water-immiscible solvent component (bii), the soybean based plant oil may include for example methyl soyate. In another more specific embodiment of the turpentine based plant oil useful as the water-immiscible solvent component (bii), the turpentine based plant oil may include for example OD-1, ND-45, and ND-60 (products which are commercially available from Fubang Bio. Co.); and mixtures thereof.

A combination of two or more of the above solvents may be used as the water-immiscible solvent, component (bii). For example, in one embodiment, component (bii) may include a mixture of: (biiα) a hydrocarbon compound such as Solvesso 200#; and (biiβ) a soybean based plant oil compound such as methyl soyate.

In one preferred embodiment, the water-immiscible solvent used in the EC formulation can be for example a mixture of methyl soyate and Solvesso 200# in a ratio of methyl soyate to Solvesso 200# in a range of from about 3:1 to about 1:1.

In terms of parts per 100 parts (g) of pesticide EC, the concentration of the water-immiscible solvent can range from about 20 parts to about 40 parts in one embodiment, and from about 25 parts to about 35 parts in another embodiment.

In preparing the solvent package, component (b) above, the total concentration of the solvent package, i.e., the combination of the above water-miscible and water-immiscible solvents (components (bi) and (bii), respectively) together may be, for example, generally in a ratio of water-miscible solvent to water-immiscible solvent in the range of from about 2:1 to about 1:1 in one embodiment, and from about 4:3 to about 1:1 in another embodiment; and from about 3:2 to about 1:1 in still another embodiment.

Component (c) useful in the EC formulation of the present invention includes a complex surfactant package which may be a combination of (ci) at least one nonionic surfactant; and (cii) at least one anionic surfactant as co-solvents.

The nonionic surfactant useful for forming the surfactant package of the present invention may include for example primary alcohol ethoxylates; secondary alcohol ethoxylates; ethylene oxide-propylene oxide (EO-PO) copolymers; and a combination of two or more of the above nonionic surfactants.

Specific embodiments of the primary alcohol ethoxylates useful as the nonionic surfactant, component (ci), may include for example various commercially available products sold under the tradename Ecosurf such as Ecosurf EH-3 and Ecosurf EH-9; and mixtures thereof. Specific embodiments of the secondary alcohol ethoxylates useful as the nonionic surfactant, component (di), may include for example various commercially available products sold under the tradename Ecosurf such as Ecosurf 15-S-9, Ecosurf 15-S-5 and Ecosurf TMN-6; and mixtures thereof. Specific embodiments of the EO-PO copolymers useful as the nonionic surfactant, component (di), may include for example various commercially available products sold under the tradename Ecosurf such as Ecosurf L-61, and Ecosurf L-64; and mixtures thereof. A combination of two or more of the above nonionic surfactants may be used as the surfactant, component (ci).

In terms of parts per 100 parts (g) of pesticide EC, the concentration of the nonionic surfactant can range from about 10 parts to about 20 parts in one embodiment, and from about 10 parts to about 15 parts in another embodiment. Above the concentration of 20 parts, a further amount of the surfactant is not cost effective and may cause a negative effect on A.I. Below the concentration of 10 parts, effective dilution stability may not be achieved.

The anionic surfactant useful for forming the surfactant package of the present invention may include for example other dialkyl sulfosuccinates; and a combination of two or more different anionic surfactants.

A specific embodiment of the dialkyl sulfosuccinates useful as the anionic surfactant, component (dii), may include for example Triton GR-5M. A combination of two or more of the above anionic surfactants may be used as the surfactant, component (cii).

The concentration of the anionic surfactant used in forming the surfactant package of the present invention may range generally from about 1 wt % to about 10 wt % in one embodiment, from about 2 wt % to about 8 wt % in another embodiment, and from about 3 wt % to about 6 wt % in still another embodiment, based on the total weight of components in the surfactant package.

In one preferred embodiment, the complex surfactant package, component (c), may include for example commercially available products such as Ecosurf EH-6 as component (ci); and may include for example commercially available products such as Triton GR-7M as component (cii).

In preparing the surfactant package, component (c) above, the total concentration of the surfactant package, i.e., the combination of the above nonionic and anionic surfactants (components (ci) and (cii), respectively) together may be, for example, generally from about 5 wt % to about 30 wt % in one embodiment, from about 10 wt % to about 25 wt % in another embodiment, and from about 17.5 wt % to about 22.5 wt % in still another embodiment, based on the total weight of components in the surfactant package.

In terms of parts per 100 parts (g) of pesticide EC, the anionic surfactant can range from about 2 parts to about 10 parts in one embodiment, and from about 4 parts to about 8 parts in another embodiment.

The process and type of equipment used to prepare the pesticide formulation of the present invention includes blending or mixing of the above-described components in conventional mixing equipment or vessels known in the art and under conventional mixing conditions. For example, the preparation of the pesticide formulation of the present invention is achieved by blending, in known mixing equipment, components (a)-(c) and optionally (d) any other desirable additives.

All the above compounds of the pesticide formulation are typically mixed and dispersed in a vessel at a temperature enabling the preparation of an effective pesticide formulation. For example, the temperature during the mixing of the above components may be generally from about 10° C. to about 40° C. in one embodiment, and from about 15° C. to about 30° C. in another embodiment. In one preferred embodiment, the mixing can be carried out at ambient temperature (about 23° C.).

The preparation of the pesticide formulation of the present invention, and/or any of the steps thereof, may be a batch or a continuous process. In a preferred embodiment, the mixing process of the pesticide formulation components and the mixing equipment used in the process may be any vessel and ancillary equipment well known to those skilled in the art.

The pesticide formulation prepared by the above process of the present invention exhibits several unexpected and unique properties. For example, one of the more important properties of the pesticide formulation is that no crystals form in the pesticide formulation when the pesticide formulation subjected to cold temperatures, i.e., the “cold storage stability performance” of the pesticide formulation. Generally, the cold storage stability performance property can be determined by visual observation of the formation of crystals in the formulation. Another beneficial property that the pesticide formulation exhibits is a 20× dilution stability. Generally, the 20× dilution stability performance of the pesticide formulation can be determined by visual observation of the formation of crystals leading to dilution instability.

Still in another beneficial property that the pesticide formulation exhibits is its capability of being able to use the formulation on a universal basis.

### EXAMPLES

The following Examples and Comparative Examples further illustrate the present invention in more detail but are not to be construed to limit the scope thereof.

In the following Examples and Comparative Examples, the following raw materials or components described in Table II were used for preparing the EC for the pesticide formulations and for evaluating the pesticide formulations.

TABLE II
Raw Materials

| | Generic | |
|---|---|---|
| | Chemical Name | |
| Component | and/or Function | Supplier |
| imidacloprid | pesticide active | Yangnong Chemical Co. |
| Pesticide (95%) | ingredient | |
| indoxacarb (96%) | pesticide active | Gaozheng Chemical Co. |
| | ingredient | |
| N-methyl | solvent | Sinopharm Chemical |
| pyrrolidinone | | Reagent Co. |
| dimethyl sulfoxide | solvent | Sinopharm Chemical |
| | | Reagent Co. |
| gamma-butyrolactone | solvent | Sinopharm Chemical |
| | | Reagent Co. |
| Solvesso ™ 200# | solvent | Exxon Mobile |
| methyl soyate | solvent | Fubang Bio. Co. |
| methyl caprylate | solvent | Fubang Bio. Co. |
| Ecosurf ™ 1 EH-6 | surfactant | The Dow Chemical Company |
| Triton ™ GR-7M | surfactant | The Dow Chemical Company |
| Ecosurf XH | surfactant | The Dow Chemical Company |
| Ecosurf L-61 | surfactant | The Dow Chemical Company |
| Ecosurf 15-S-5 | surfactant | The Dow Chemical Company |

General Process for Preparing Emulsifiable Concentrates

Pesticide emulsifiable concentrates were prepared using the following steps:

Step (1): a pesticide active ingredient (A.I.) was added and mixed into a water-miscible polar solvents package to obtain a uniform A.I. solution;

Step (2): the water-immiscible solvents package was introduced into above A.I. solution of step (1) to obtain a homogeneous solution; and

Step (3): the surfactant package was incorporated into the above homogeneous solution of step (2) to obtain a resultant EC formulation for performance evaluation.

General Process for Evaluating the Performance of Emulsifiable Concentrates

(a) Cold Storage Stability

The EC formulation prepared as described above was placed in chamber under a temperature of 0° C. for a period of time of 1 week; and the EC formulation was visually observed after a 1-week period of time. If, by visual inspection, the EC formulation was still transparent and homogeneous after 1 week at 0° C., the EC formulation was considered a “good” sample with excellent cold storage stability. If, by visual inspection, the EC formulation had some crystals present in the formulation after 1 week at 0° C., the EC formulation was considered a “bad” sample with poor or unacceptable cold storage stability.

(b) 20× Dilution Stability

The EC formulation prepared as described above was diluted twenty times (20×) using hard water in a vessel; and after each of the 20× dilution, the vessel with the formulation was shaken to mix the diluted formulation. Then, the resulting diluted EC formulation was placed in a chamber at a temperature of 30° C. for a time period of 2 hours (hr) for later visual inspection. If, by visual inspection, no crystals appeared in the diluted EC formulation after 2 hr at 30° C., the diluted EC formulation was considered as a “good” sample with excellent dilution stability. However, if by visual inspection, crystals existed in the diluted EC formulation after 2 hr at 30° C., the diluted EC formulation was considered a “bad” sample with poor or unacceptable dilution stability.

Solvent Package for Pesticide Active Solution Physical Stability

To evaluate the physical stability of a pesticide active solution, a number of samples were prepared with varied water-miscible solvent ratios and with a high concentration of a pesticide active in the solvent as described in Table III. The samples (S1 to S9) were then studied.

TABLE III
Imidacloprid Active Dissolved in Varied Solvent Formulae

| | Sample | | | | | | | | |
|---|---|---|---|---|---|---|---|---|---|
| Solvent | S1 | S2 | S3 | S4 | S5 | S6 | S7 | S8 | S9 |
| NMP/DMSO (wt %) | 9/1 | 8/2 | 7/3 | 6/4 | 5/5 | 4/6 | 3/7 | 2/8 | 1/9 |

Note for Table III:
The solid content of imidacloprid is kept at 30 wt %.

### Examples 1-3 and Comparative Example A-I—Preparation of EC Formulations for Physical Stability and Dilution Stability Evaluations

The imidacloprid emulsifiable concentrate formulations used in these examples are described in Table IV. The sample formulations designated as “Ex. 1”, “Ex. 2” and “Ex. 3” are Examples 1, 2 and 3 of the present invention, respectively; and the sample formulations designated as “Comp. Ex. A-Comp. Ex. I” are Comparative Example A to Comparative Example I, respectively, with different compositions.

TABLE IV
Imidacloprid Emulsifiable Concentrates Formulae

| | Examples | | | | | | | | | | | |
|---|---|---|---|---|---|---|---|---|---|---|---|---|
| | Ex. | Ex. | Comp. | Comp. | Comp. | Comp. | Comp. | Comp. | Comp. | Comp. | Comp. | Ex. |
| Components⁽¹⁾ | 1* | 2* | Ex. A | Ex.B | Ex. C | Ex. D | Ex. E | Ex.F | Ex. G | Ex. H | Ex. I | 3* |
| imidacloprid | 9.4 | 9.4 | 9.4 | 9.4 | 9.4 | 9.4 | 9.4 | 9.4 | 9.4 | 9.4 | 9.4 | |
| (95%) | | | | | | | | | | | | |
| indoxacarb | | | | | | | | | | | | 16.4 |
| (96%) | | | | | | | | | | | | |
| NMP | 23.0 | 24.0 | 23.0 | 23.0 | 31.6 | 17.1 | 23.0 | 23.0 | 23.0 | 23.0 | 23.0 | 19.0 |
| DMSO | 17.3 | 16.3 | | 17.3 | 23.8 | 12.9 | 17.3 | 17.3 | 17.3 | 17.3 | 17.3 | 14.3 |
| gamma- | | | 17.3 | | | | | | | | | |
| butyrolactone | | | | | | | | | | | | |
| Solvesso ™ | 10.2 | 10.2 | 10.2 | | 5.1 | 15.0 | 20.2 | 10.2 | 10.2 | 10.2 | 10.2 | 10.2 |
| 200# | | | | | | | | | | | | |
| methyl soyate | 20.2 | 20.2 | 20.2 | | 10.1 | 25.0 | 10.2 | 20.2 | 20.2 | 20.2 | 20.2 | 20.2 |
| methyl | | | | 30.4 | | | | | | | | |
| caprylate | | | | | | | | | | | | |
| Ecosurf ™ | 15.0 | 15.0 | 15.0 | 15.0 | 15.0 | 15.0 | 15.0 | 20.0 | 15.0 | 10.0 | 10.0 | 15.0 |
| EH-6 | | | | | | | | | | | | |
| Triton ™ | 5.0 | 5.0 | 5.0 | 5.0 | 5.0 | 5.0 | 5.0 | | | | | 5.0 |
| GR-7M | | | | | | | | | | | | |
| Ecosurf XH | | | | | | | | | 5.0 | | | |
| Ecosurf L-61 | | | | | | | | | | 10.0 | | |
| Ecosurf 15-S-5 | | | | | | | | | | | 10.0 | |

⁽¹⁾All Components are in wt %.
*Examples of the present invention.

Solvent Package—Pesticide Active Solution Physical Stability

TABLE V
Evaluation Results of Physical Stability of Varied Solvent Ratio

| Sample | Physical Stability (0° C., overnight) |
|---|---|
| S1 | homogeneous system, transparent |
| S2 | homogeneous system, transparent |
| S3 | homogeneous system, transparent |
| S4 | homogeneous system, transparent |
| S5 | homogeneous system, transparent |
| S6 | homogeneous system, transparent |
| S7 | crystals appeared |
| S8 | crystals appeared |
| S9 | crystals appeared |

From the physical stability results described in Table V, it can be determined that the imidacloprid solution can be unstable if the dosage of DMSO in the mixture of solvents increases to a high level such as greater than 70 wt %. The results described in Table V indicates that, in one preferred embodiment, the ratio of NMP to DMSO is preferably from about 3:2 to about 9:1, and more preferably in the range of from about 3:2 to about 4:1. On the basis of solubility parameter calculation results of the solvent mixture and imidacloprid, in a preferred embodiment, the ratio of NMP to DMSO is generally about 4:3 to achieve the highest active dissolving ability.

EC Formulation—Physical Stability (Cold Storage Stability)

The EC formulation samples described in Table VI were visually inspected with the naked eye to determine the cold storage stability of the EC formulation and to determine which formulation can be rated “good” versus “bad” as described above. The evaluation results of different examples of EC formulations are described in Table VI.

TABLE VI
Evaluation Results of Cold Storage Stability

| Example No. | Cold Storage (1 week at 0° C.) |
|---|---|
| Ex. 1* | homogeneous system, transparent |
| Ex. 2* | homogeneous system, transparent |
| Comp. Ex. A | crystals appeared |
| Comp. Ex. B | crystals appeared |
| Comp. Ex. C | homogeneous system, transparent |
| Comp. Ex. D | crystals appeared |
| Comp. Ex. E | crystals appeared |
| Comp. Ex. F | crystals appeared |
| Comp. Ex. G | crystals appeared |
| Comp. Ex. H | homogeneous system, transparent |
| Comp. Ex. I | heterogeneous system |
| Ex. 3* | homogeneous system, transparent |

*Example of the present invention.

The formulation sample of Ex. 1 was observed to be transparent and homogeneous even after 1 week of cold storage; and thus shows excellent cold storage stability. The results related to the formulation sample of Ex. 1 demonstrates that incorporating selective water-immiscible solvents and a selective surfactants package is not detrimental to the A.I. solubility in water-miscible solvents systems.

The ratio of NMP to DMSO was changed in the formulation sample of Ex. 2. The formulation sample of Ex. 2 was observed to be transparent and homogeneous even after 1 week of cold storage; and thus, shows excellent cold storage stability. The results related to the formulation sample of Ex. 2 demonstrates that incorporating selective water-immiscible solvents and a selective surfactants package is not detrimental to the A.I. solubility in water-miscible solvents systems.

The solvent package components and the ratio of the components in Comp. Ex. A-Comp. Ex. E were varied. In Comp. Ex. A, the water-miscible solvent components were changed from (a) the combination of NMP and DMSO to (b) the combination of NMP and gamma-butyrolactone; and, the ratio of NMP to gamma-butyrolactone used in Comp. Ex. A was the same as the ratio of NMP to DMSO used in Ex. 1. The other components in Comp. Ex. A and their ratios are the same as in Ex. 1. Crystals appeared in the formulation sample of Comp. Ex. A after cold storage demonstrating that the change of the water-miscible solvent package in the formulation sample is detrimental for the solubility property of the A.I.

In Comp. Ex. B, the water-immiscible solvent components were changed from (a) the combination of Solvesso 200# and methyl soyate to (b) only methyl caprylate, but the ratios and other components were kept the same in Comp. Ex. B as in Ex. 1. Crystals were formed in the formulation of Comp. Ex. B after cold storage which illustrates an unacceptable physical stability property.

In Comp. Ex. C and in Comp. Ex. D, the ratio of water-miscible solvent and water-immiscible solvent were changed as described in Table IV. The sample formulation of Comp. Ex. E shows excellent cold storage stability with the increase of water-miscible solvent dosage; and the sample formulation of Comp. Ex. F shows bad cold storage stability with the increase of water-immiscible solvent present in the formulation sample.

In Comp. Ex. E, the ratio between two water-immiscible solvents was changed. Crystals appeared in the sample formulation of Comp. Ex. E which demonstrates that the ratio of water-immiscible solvents used in the sample formulation is important and can have an effect on the final formulation product.

In the formulations of Comp. Ex. F, Comp. Ex. G, Comp. Ex. H, and Comp. Ex. I, the surfactants package was varied. Different surfactant combinations used in the sample formulations show different cold storage stability results. The cold storage stability rating for Comp. Ex. F and Comp. Ex. G was “bad”; for Comp. Ex. H was “excellent”; and for Comp. Ex. I was “moderate”. Although Comp. Ex. C and Comp. Ex. H show a “homogeneous system” and are “transparent” as described in Table VI above, Comp. Ex. C and Comp. Ex. H do not have dilution stability as shown in Table VII below.

In the sample formulation of Ex. 3, the pesticide A.I. was changed. The sample formulation of Ex. 3 showed very excellent cold storage stability which demonstrates the universality of the solvent and surfactant systems or packages of the present invention.

EC Formulation—Dilution Stability

EC formulation dilution stability evaluation results described in Table VII were obtained by studying the different sample formulations prepared in the above Examples.

TABLE VII
Evaluation Results of Dilution Stability

| Sample | Dilution Stability (20X, 30° C.) |
|---|---|
| Ex. 1* | 2 hours, no crystals, little cream |
| Ex. 2* | 2 hours, no crystals, little cream |
| Comp. Ex. A | 1 hour, crystals |
| Comp. Ex. B | 10 minutes, crystals |
| Comp. Ex. C | 30 minutes, crystals |
| Comp. Ex. D | 10 minutes, crystals |
| Comp. Ex. E | 1 hour, crystals |
| Comp. Ex. F | 30 minutes, crystals |
| Comp. Ex. G | 30 minutes, crystals |
| Comp. Ex. H | 30 minutes, crystals |
| Comp. Ex. I | 30 minutes, crystals |
| Ex. 3* | 2 hours, no crystals, no cream |

*Example of the present invention.

No crystals could be observed after 20× dilution for 2 hr in the sample formulation of the present invention described in Ex. 1, therefore earning a rating of “excellent” dilution stability. The non-formation of crystals in Ex. 1 demonstrates that the solvent system and surfactant package of the present invention has the properties necessary generates a high quality emulsion.

In the formulation of Ex. 2, the ratio between NMP and DMSO was changed. No crystals could be observed after 20× dilution for 2 hr, demonstrating that the sample formulation of Ex. 2 had an excellent dilution stability. The non-formation of crystals in Ex. 2 demonstrates that the solvent system and surfactant package of the present invention has the properties necessary to generate a high quality emulsion.

The formulations of Comp. Ex. A-Comp. Ex. E are comparative examples with various solvent package components at various ratios. For example, in Comp. Ex. A-Comp. Ex. E crystals appeared in the formulation in less than 2 hr. The results of the above comparative examples, indicate that the property of dilution stability can be rated “bad” when there is a change in: (i) the water-miscible solvent components used (e.g., Comp. Ex. A), (ii) the water-immiscible solvent components used (e.g., Comp. Ex. B), (iii) the ratio of the water-miscible solvent to the water-immiscible solvent used (e.g., Comp. Ex. D versus Comp. Ex. E), and (iv) the ratio of water-immiscible solvents used (e.g., Comp. Ex. E).

The formulations of Comp. Ex. F-Comp. Ex. I are comparative examples with various surfactants packages. For the above comparative examples, crystals appeared in the formulations in less 2 hr. The formation of crystals in the formulations indicated “bad” emulsification behavior for the solvent system of the above comparative examples after changing the surfactants package of the formulations.

The present invention formulation is further illustrated by the sample formulation of Ex. 3. The pesticide A.I. was changed in the formulation of Ex. 3. The formulation of Ex. 3 showed very excellent dilution stability, demonstrating the universality of the solvent and surfactant system of the present invention.

A comparison of the results of Ex. 1 and Ex. 2 versus Comp. Ex. A-D illustrates that: (i) a water-miscible solvent to water-immiscible solvent weight ratio can be used at a range of from about 2:1 to about 1:1 in one embodiment; and (ii) a methyl soyate to Solvesso 200# can be used at a range of from about 3:1 to about 1:1 in another embodiment.

A comparison result of Ex. 1 and Ex. 2 versus Comp. Ex. F-Comp. Ex. I illustrates that: (i) a combination of (a) an alkoxylated alcohol nonionic surfactant and (b) a dialkyl sulfosuccinate anionic surfactant can be used as an emulsifier, and (ii) the EC formulations of polar A.I. are stable both in (1) a EC formulation and (2) when the formulation is diluted.

While it is very challenging to prepare emulsifiable concentrates of polar pesticide active ingredients having a high concentration of A.I. and an excellent dilution stability, by selectively choosing the proper water-miscible solvent in combination with the proper water-immiscible solvent to form the solvent package of the present invention, a high concentration of A.I. can be achieved which can provide excellent physical stability under ambient temperature. And, the unique surfactant combination could provide a high quality emulsion after the EC formulation is diluted with water, without the problem A.I. crystallization.

The water-miscible solvent package of the present invention may include for example, polar solvents for polar pesticide active dissolution at high concentration such as NMP and DMSO (the range of NMP to DMSO can be for example from about 3:2 to about 4:1 in one embodiment).

The water-immiscible solvent package of the present invention may include for example, a hydrocarbon mixture and methyl soyate for enhancing dilution stability, or in other words, for suppressing crystal formation. The water-immiscible solvent package can be, for example, a combination of methyl soyate and Solvesso 200# (the ratio of methyl soyate to Solvesso 200# can be for example from about 3:1 to about 1:1 in one embodiment).

Generally, the ratio of water-miscible solvent to water-immiscible solvent can be maintained at a range of from about 2:1 to about 1:1 in one embodiment.

In another embodiment, the surfactant system of the present invention can be a combination of a nonionic surfactant and an anionic surfactant. For example, the nonionic surfactant may be a primary alcohol ethoxylate with a sufficient ethoxylate number. The nonionic surfactant can be for example Ecosurf EH-6 and the anionic surfactant can be for example a dialkyl sulfosuccinate, such as Triton GR-7M.

The solvent and surfactant package of the present invention exhibits an unexpected synergistic effect to the properties of an EC formulation and provides a unique high quality EC formulation which shows universality to other polar pesticide actives such as indoxacarb.

1. A polar pesticide formulation comprising:
(a) a polar pesticide active ingredient;
(b) a solvent package; wherein the solvent package includes a mixture of:
(bi) at least one water-miscible, low toxicity, high polarity solvent package; wherein the at least one water-miscible, low toxicity, high polarity solvent package includes a mixture of:
(biα) a pyrrolidone compound; and
(biβ) a sulfur-containing compound;
(bii) at least one water-immiscible, low polarity solvent package; wherein the at least one water-immiscible, low polarity solvent package includes a mixture of:
(biiα) a hydrocarbon compound; and
(biiβ) a soybean based plant oil compound; and
(c) a complex surfactant package; wherein the complex surfactant package includes a mixture of:
(ci) at least one nonionic surfactant; and
(cii) at least one anionic surfactant.

2. The formulation of claim 1, wherein the polar pesticide active ingredient, component (a), is selected from the group consisting of imidacloprid, thiamethoxam, clothianidin, acetamiprid, clopyralid, diflufenican, tebuconazole, oxyfluorfen, propanil, oryzalin, propoxur, thiocloprid, buprofezin, indoxacarb, bentazone, and mixtures thereof.

3. The formulation of claim 1, wherein the concentration of the polar pesticide active ingredient, component (a), is in the range of from about 5 weight percent to about 16 weight percent.

4. The formulation of claim 1, wherein the solvent package, component (b), comprises a combination of: (bi) a water-miscible solvent and (bii) a water-immiscible solvent; and the weight ratio of the water-miscible solvent to the water-immiscible solvent is in the range of from about 3:2 to about 4:1.

5. The formulation of claim 1, wherein the complex surfactant package comprises a combination of: (ci) a nonionic surfactant and (cii) an anionic surfactant; and wherein the concentration of the combination of the nonionic surfactant and anionic surfactants together is from about 5 weight percent to about 30 weight percent.

6. A pesticide for plants comprising the formulation of claim 1.

7. A process for preparing a pesticide formulation comprising admixing:
(a) a polar pesticide active ingredient;
(b) a solvent package including a mixture of:
(bi) at least one water-miscible low toxicity and high polarity solvent package; wherein the at least one water-miscible low toxicity and high polarity solvent package includes a mixture of:
(biα) a pyrrolidone compound; and
(biβ) a sulfur-containing compound;
(bii) at least one water-immiscible eco-friendly and low polarity solvent package; wherein the at least one water-immiscible eco-friendly and low polarity solvent package includes a mixture of:
(biiα) a hydrocarbon compound; and
(biiβ) a soybean based plant oil compound; and
(c) a complex surfactant package including a mixture of:
(ci) at least one nonionic surfactant; and
(cii) at least one anionic surfactant.
